(19) United States
(12) Patent Application Publication
(10) Pub. No.: US 2015/0249719 A1
(43) Pub. Date: Sep. 3, 2015

(54) METHOD AND DEVICE FOR PUSHING INFORMATION

(71) Applicant: TENCENT TECHNOLOGY (SHENZHEN) COMPANY LIMITED, Shenzhen,GD (CN)

(72) Inventors: Ping Wen, Shenzhen (CN); Chao Zhao, Shenzhen (CN); Yanping Gao, Shenzhen (CN); Yuqiang Chu, Shenzhen (CN); He Zou, Shenzhen (CN)

(21) Appl. No.: 14/417,303

(22) PCT Filed: Jul. 25, 2013
(86) PCT No.: PCT/CN2013/080077

§ 371 Date: Jan. 26, 2015

(30) Foreign Application Priority Data
Jul. 25, 2012 (CN) 201210258830.5

(51) Int. Cl. H04L 29/08; G06F 17/30

(52) U.S. Cl. CPC H04L 67/26; H04L 67/10; G06F 17/30864; G06F 17/3033

(57) ABSTRACT

The application provides a method and a device for pushing information and relates to internet technologies. The method includes: receiving an access request sent by a client, wherein the access request carries information of the client; obtaining dimensions of at least one category of the client according to the information of the client, combining the dimensions of at least one category of the client dimensionally, and obtaining at least one dimension combination of the client; calculating a hash value of each dimension combination of the client, searching for push information matching the hash value, and returning the push information searched out to the client. In the application, by initiatively pushing information to the client through dimensions of multiple categories of the client, the pushed information better meets the needs of the client, thereby improving experience of a user browsing a microblog channel.

### FIELD OF THE DISCLOSURE

The present invention relates to internet technologies, and more particularly, to a method and a device for pushing information.

### BACKGROUND

A microblog is a platform for information sharing, transmission and obtaining based on user relation. A user may organize an individual community, update information and realize information sharing instantly by using web, wireless application protocol (WAP) and various kinds of clients. As the microblog being widely adopted, more operators push a service of a microblog channel. Based on tons of user content produced by the microblog, the most essential content, such as a latest updated message or a most concerned message, is screened by the microblog channel from the microblog for the user. A microblog channel may automatically release broadcast information in real time. Specifically, after a user enters into a user channel, some information, including news, a microblog update message or information of other microblog users, is pushed to a client by a server.

In an existing method for pushing information, the latest updated message or the most concerned message is simply pushed to a main page of a user microblog channel. However, these messages do not necessarily include a message that the user is interested in, that is, the user can not obtain information he/she is interested in from pushed information. The pushed information that a huge number of users are not interested in consumes a large amount of network traffic. Even though the pushed information includes the information that the user is interested in, the user also needs to search the pushed information for the information that is of interest to the user, subsequently, efficiency for pushing information may be lower, resource occupation may be higher, which makes user experience worse.

### SUMMARY

In order to improve the efficiency for pushing information, reduce resource occupation, and improve user experience when a user browses a microblog channel, the embodiments of the present invention provide a method and a device for pushing information. The technical solution is as below.

In an aspect, a method for pushing information is provided, which includes:

receiving an access request sent by a client, wherein the access request carries information of the client;

obtaining, according to the information of the client, dimensions of at least one category of the client, combining the dimensions of at least one category of the client dimensionally, and obtaining at least one dimension combination of the client; and

for each dimension combination of the client, calculating a hash value of the dimension combination, searching for push information matching the hash value, and returning the push information searched out to the client.

The information of the client includes at least one of: capability information of the client, Internet Protocol (IP) address information, version information of a browser, and one or more pieces of network information of the client, and the dimensions of at least one category of the client are obtained through at least one of:

determining the capability information of the client as a dimension of a first category of the client;

obtaining, according to the IP address information, area information of the client, and determining the area information of the client as a dimension of a second category of the client;

determining the version information of the browser as a dimension of a third category of the client;

obtaining, according to the version information of the browser, a service source of the client, and determining the service source of the client as a dimension of a fourth category;

obtaining, according to the network information of the client, information of a network operator to which the client belongs, and determining the information of the network operator to which the client belongs as a dimension of a fifth category of the client; and

obtaining, according to the information of the client, a gender of a client user, and/or, a keyword of a client user, determining the gender of the client user and/or the keyword of the client user as a dimension of a sixth category.

Combining the dimensions of at least one category of the client dimensionally and obtaining at least one dimension combination of the client include:

performing a Cartesian product operation on the dimensions of at least one category of the client, and obtaining at least one dimension combination of the client.

Searching for push information matching the hash value and returning the push information searched out to the client include:

searching for the push information matching the hash value in a cache unit; and

returning the push information searched out to the client, when the push information matching the hash value is searched out in the cache unit.

The method further includes:

obtaining a correspondence between the push information having the at least one dimension combination of the client and the at least one dimension combination from a loading unit, when the push information matching the hash value is not searched out in the cache unit; and

comparing the hash value of each dimension combination of the client with hash value of each dimension combination of the push information respectively, and storing the push information into the cache unit, when there is a same hash value between hash values of all dimension combinations of the client and hash values of corresponding dimension combinations of the push information.

Searching for the push information matching the hash value in the cache unit includes:

comparing the hash value of each dimension combination of the client with the hash value of dimension combination of the corresponding push information in the cache unit respectively; and

searching out the push information matching the hash value, when the hash value of each dimension combination of the client is the same as the hash value of the corresponding dimension combination of the push information.

The method further includes:

obtaining a correspondence between the push information and all dimension combinations of the push information, before receiving the access request sent by the client; and

obtaining, according to the dimension combinations included in the obtained correspondence, categories of all the dimensions of the push information and the largest level of each dimension, and calculating the hash value of each dimension combination.

From another aspect, a device for pushing information is also provided, which includes:

a receiving module, configured to receive an access request sent by a client, wherein the access request carries information of the client;

a dimension-combination obtaining module, configured to obtain, according to the information of the client, dimensions of at least one category of the client, combine the dimensions of at least one category of the client dimensionally, and obtain at least one dimension combination of the client; and

an information pushing module, configured to calculate a hash value of each dimension combination of the client respectively, search for push information matching the hash value, and return the push information searched out to the client.

The information of the client includes at least one of: capability information of the client, IP address information, version information of a browser and network information of the client, and the dimension-combination obtaining module includes a dimension generating unit which is configured to obtain dimensions of at least one category of the client through at least one of:

determining the capability information of the client as a dimension of a first category of the client;

obtaining, according to the IP address information, area information of the client, and determining the area information of the client as a dimension of a second category of the client;

determining the version information of the browser as a dimension of a third category of the client;

obtaining, according to the version information of the browser, a service source of the client, and determining the service source of the client as a dimension of a fourth category;

obtaining, according to the network information of the client, information of a network operator to which the client belongs, and determining the information of the network operator to which the client belongs as a dimension of a fifth category; and obtaining, according to the information of the client, a gender of a client user and/or a keyword of a client user, determining the gender of the client user and/or the keyword of the client user as a dimension of a sixth category.

The dimension-combination obtaining module includes:

a calculating unit, configured to perform a Cartesian product operation on at least one dimension of the client, and to obtain at least one dimension combination of the client.

The information pushing module includes:

a searching unit, configured to search for the push information matching the hash value in a cache unit; and

a pushing unit, configured to return the push information searched out to the client, when the push information matching the hash value has been searched out in the cache unit.

The device further includes:

an obtaining module, configured to obtain a correspondence between the push information having at least one dimension combination of the client and the at least one dimension combination from a loading unit, when the push information matching the hash value is not searched out in the cache unit, and to compare the calculated hash value of the dimension combination of the client with the hash value of the dimension combination of the push information, obtain the push information matching the hash value, when there is a same hash value between hash values of all dimension combinations of the client and hash values of corresponding dimension combinations of the push information, and store the push information into the cache unit.

The searching unit in the information pushing module is configured to compare the hash value of each dimension combination of the client with the hash value of the corresponding dimension combination of the push information respectively, and to search out the push information matching the hash value, when the hash value of each dimension combination of the client is the same as the hash value of the corresponding dimension combination of the push information.

The device further includes:

a loading module, configured to obtain a correspondence between the push information and all dimension combinations of the push information, before the receiving module receives the access request sent by the client, and to obtain, according to the obtained correspondence with the dimension combinations, categories of all the dimensions in the dimension combination and a largest level of each dimension, and calculate the hash value of each dimension combination.

The technical solution provided by the embodiments of the present invention brings beneficial effects. An access request sent by a client is received, wherein the access request carries information of the client; dimensions of at least one category of the client are obtained according to the information of the client, the dimensions of at least one category of the client are combined dimensionally and at least one dimension combination of the client is obtained; and a hash value of each dimension combination of the client is calculated respectively, push information matching the hash value is searched for, and the found push information is returned to the client. By initiatively pushing information to the client through dimensions of at least one category of the client, the pushed information better meets the needs of the client, thereby improving experience of a user browsing a microblog channel.

### BRIEF DESCRIPTION OF DRAWINGS

To illustrate technical solutions of the embodiments of the present invention or the conventional method more clearly, a brief introduction on the accompanying drawings necessary in the description of the embodiments is given below. Apparently, the accompanying drawings described below are merely some embodiments of the present invention, based on which other drawings can be obtained by those skilled in the art without any inventive efforts.

FIG. 1 is a flowchart of a method for pushing information provided by an embodiment of the present invention.

FIG. 2 is a flowchart of a method for pushing information provided by an embodiment of the present invention.

FIG. 3 is a schematic diagram illustrating structure of a device for pushing information provided by an embodiment of the present invention.

FIG. 4 is a schematic diagram illustrating another structure of a device for pushing information provided by an embodiment of the present invention.

FIG. 5 is a schematic diagram illustrating structure of a device for pushing information provided by an embodiment of the present invention.

FIG. 6 is a schematic diagram illustrating another structure of a device for pushing information provided by an embodiment of the present invention.

### EMBODIMENTS OF THE INVENTION

In order to make the objective, technical solution and advantages of the present invention more clearly, a detailed description of the present invention is hereinafter given with reference to the attached drawings and embodiments.

Cartesian product is defined as below.

A and B are assumed to be sets. An element of A called a first element and an element of B called a second element constitute an ordered pair. A set of all ordered pairs like this, called Cartesian product of A and B, is denoted as A×B. Symbolic Cartesian product is A×B={<x, y>|xεAΛyεB}. For example, when A={a, b}, B={0, 1, 2}, A×B={<a, 0>, <a,1>, <a, 2>, <b, 0>, <b, 1>, <b, 2>} and B×A={<0, a>, <0, b>, <1, a>, <1, b>, <2, a>, <2, b>}.

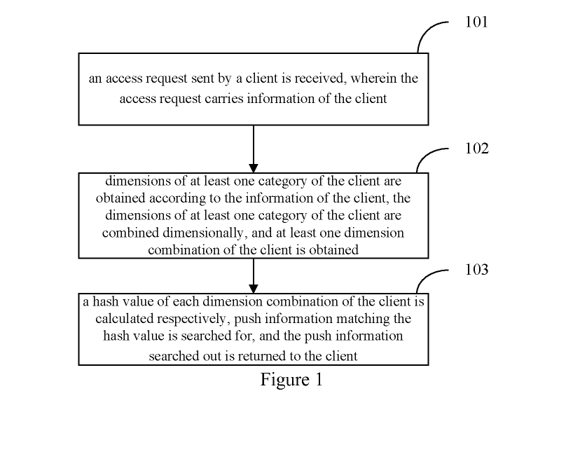

Referring to FIG. 1, the embodiment provides a method for pushing information, which may be executed by a computing device such as a network server, wherein the method specifically includes the following steps.

In step 101, an access request sent by a client is received, wherein the access request carries information of the client.

In step 102, dimensions of at least one category of the client are obtained according to the information of the client, the dimensions of at least one category of the client are combined dimensionally, and at least one dimension combination of the client is obtained.

In step 103, a hash value of each dimension combination of the client is calculated respectively, push information matching the hash value is searched for, and the push information searched out is returned to the client.

The information of the client includes at least one of: capability information of the client, IP address information, version information of a browser, and network information of the client. Dimensions of multiple categories related to the client are obtained through at least one of following ways.

The capability information of the client is determined as a dimension of a first category of the client.

Area information of the client, which is obtained based on the IP address information, is determined as a dimension of a second category of the client.

The version information of the browser is determined as a dimension of a third category of the client.

A service source of the client, which is obtained based on the version information of the browser, is determined as a dimension of a fourth category.

Information of a network operator to which the client belongs is obtained based on the network information of the client, and is determined as a dimension of a fifth category of the client.

At least one of gender and keyword of a client user may be obtained based on the information of the client. At least one of the gender and keyword of the client user may be determined as a dimension of a sixth category.

A process of combining dimensions of at least one category of the client and obtaining at least one dimension combination include the follows.

A Cartesian product operation is performed on the dimensions of at least one category of the client, and at least one dimension combination of the client is obtained.

A memory of a computing device for executing the method of the embodiment includes a cache unit and a loading unit. The loading unit is to load the push information and correspondences between the push information and all the dimensions of the push information from a database. The cache unit, which may be implemented by a high-speed cache, is to obtain the push information from the loading unit and to store the push information obtained.

Processes of searching for the push information matching the hash value and returning the push information searched out to the client include as below.

The push information matching the hash value is searched for in the cache unit.

When the push information matching the hash value is searched out in the cache unit, the push information searched out is returned to the client.

A process of searching for the push information matching the hash value in the cache unit includes as below.

The hash value of each dimension combination of the client is compared with a hash value of the dimension combination of the corresponding push information, respectively.

When the hash value of each dimension combination of the client is the same as the hash value of the corresponding dimension combination of the push information, the push information matching the hash value is searched out.

For example, there are a dimension combination 1 and a dimension combination 2 in the client. Dimension combination 1 whose hash value is 25 is composed of an area (Beijing) and a platform (iPhone). Dimension combination 2 whose hash value is 36 is composed of an area (Beijing) and a service source (a space platform). There are a dimension combination 1 and a dimension combination 2 in the push information. Dimension combination 1 whose hash value is 36 is composed of an area (Beijing) and a service source (a space platform). Dimension combination 2 whose hash value is 25 is composed of an area (Beijing) and a platform (iPhone). Dimension combination 1 of the client is compared with the corresponding dimension combination 2 of the push information. Dimension combination 2 of the client is compared with the corresponding dimension combination 1 of the push information. When the dimension combination 1 of the client is consistent with the corresponding dimension combination 2 of the push information, meanwhile dimension combination 2 of the client is consistent with the corresponding dimension combination 1 of the push information, the push information equal to the hash value is searched out.

The method further includes as follows.

When the push information matching the hash value is not searched out in the cache unit, a correspondence between the push information having at least one dimension combination of the client and the at least one dimension combination is obtained from the loading unit.

The hash values of all the dimension combinations of the client are compared with hash values of corresponding dimension combinations of the push information. When there is a same hash value between hash values of all the dimension combinations of the client and hash values of the corresponding dimension combinations of the push information, the push information matching the hash value is obtained, and the push information is put in the cache unit.

The method further includes the follows.

Before the access request sent by the client is received, correspondences between the push information and all the dimension combinations of the push information are obtained.

Types of all the dimensions of the push information and a largest level of each dimension are obtained, based on the dimension combination included in the obtained correspondences. The hash value of each dimension combination of the push information is calculated.

The embodiment brings beneficial effects. An access request sent by a client is received. The access request carries information of the client. Dimensions of at least one category of the client are obtained based on the information of the client. The dimensions of at least one category of the client are combined dimensionally. At least one dimension combination of the client is obtained. Hash value of each dimension combination of the client is calculated. Push information matching the hash value is searched for. The push information searched out is returned to the client. The information may be pushed to the client based on dimensions of at least one category of the client. Subsequently, requirements of the client may be better met, efficiency for pushing information may be improved, resource occupation may be reduced, and experience of a user browsing a microblog channel may be improved.

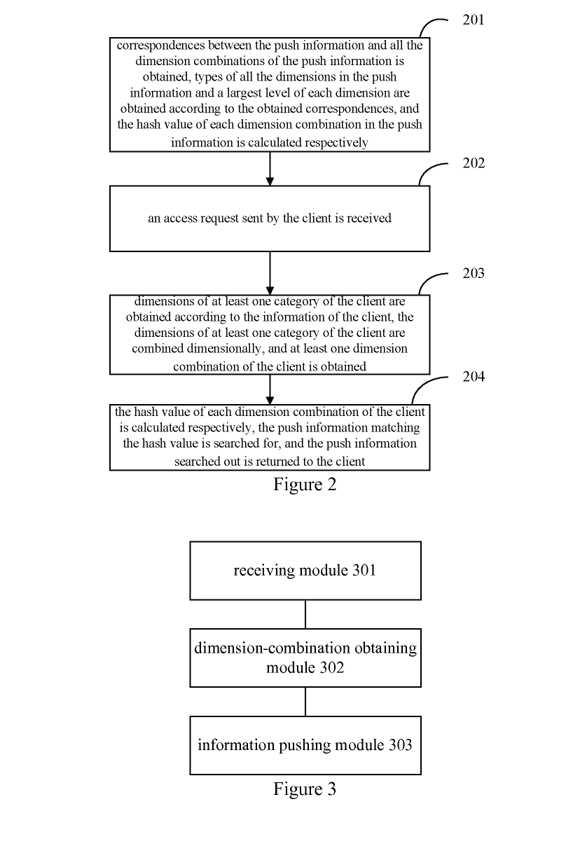

The embodiment of the present invention provides a method for pushing information. Referring to FIG. 2, the method includes the following steps.

In step 201, correspondences between push information and all the dimension combinations of the push information is obtained. Types of all the dimensions of the push information, and a largest level of each dimension are obtained, based on the obtained correspondences. Hash value of each dimension combination of the push information is calculated respectively.

In the embodiment, a backend server includes a cache unit and a loading unit. The loading unit is configured to load the push information, the correspondences between the push information and all the dimension combinations of the push information from a database, and to pre-process the loaded data, obtain types of all the dimensions and the largest level of each dimension, and to calculate the hash value of each dimension combination. After obtaining the hash value, the loading unit puts the hash value and corresponding information of the hash value into the cache unit. Subsequently, the information may be pushed to the client based on the hash value.

It should be noted that the step is optional. When the backend server has performed the foregoing processes on the data in the database, it is not necessary to execute step 201 in a specific implemented process. When the backend server has not performed the foregoing processes on the data in the database, step 201 is necessary to be executed. During a specific process of pushing information, whether to execute the step is not limited in the embodiment.

In step 202, an access request sent by the client is received.

In this step, the client sends the access request to the server. The access request may be a login request, or may also be a specific content request, which is not limited in the embodiment. However, no matter what type of the request, the information of the client will be carried in the request. The information includes but not limited to at least one of: capability information of the client, IP address information, version information of a browser and network information of the client. The capability information of the client includes a platform used by the client, such as an iPhone platform or a Symbian platform, whether the client is a touch-screen terminal, etc. The information of the client may also include user information of the client, such as a user name.

In step 203, dimensions of at least one category of the client are obtained according to the information of the client, the dimensions of at least one category of the client are combined dimensionally, and at least one dimension combination of the client is obtained.

In this step, dimensions of multiple categories of the client are obtained according to the information of the client through at least one of following ways.

The capability information of the client is determined as a dimension of a first category of the client;

Area information of the client, which is obtained based on the IP address information, is determined as a dimension of a second category of the client.

The version information of the browser is determined as a dimension of a third category of the client.

A service source of the client, which is obtained based on the version information of the browser, is determined as a dimension of a fourth category. The service source refers to a service platform that sends the request, such as a space platform, a microblog platform, and so on.

Information of a network operator to which the client belongs, which is obtained based on the network information of the client, is determined as a dimension of a fifth category.

At least one of gender and keyword of a client user, which may be obtained based on the information of the client, may be determined as a dimension of a sixth category. When the information of the client includes a user name, the backend server may have already made a statistic on the information of the user. Subsequently, the gender or keyword of the user stored in the backend may be obtained based on such information. The keyword includes an interest or a hobby of the user, which is not limited in the embodiment.

It should be noted that the six kinds of dimensions mentioned above are just examples and not limited in the embodiment.

In the embodiment, a dimension type of current request content and the largest level of each dimension are obtained according to the information of the client. For example, if Zhangsan who is in Beijing uses an iPhone to access the microblog in a touch screen version, the access request thereof carries the IP address information and the capability information of the client. The capability information of the client includes touch-screen information and platform information of the client. Specifically, dimensions of the client are China, Beijing, a touch-screen version and an iPhone platform.

Further, in the embodiment, after obtaining dimensions of multiple categories of the client, the dimensions of multiple categories of the client are combined dimensionally, and all the dimension combinations related to the client are obtained. Specifically, processes of combining multiple dimensions of the client dimensionally and obtaining multiple dimension combinations related to the client include as follows. A Cartesian product operation is performed on the multiple dimensions of the client, and the multiple dimension combinations related to the client are obtained. For example, as for Zhangsan in Beijing using the iPhone to access the microblog in the touch screen version, after combining dimensionally by adopting the Cartesian product operation, all the obtained dimension combinations are as below:

area (Beijing), source (touch-screen version), platform (iPhone);

area (Beijing), source (touch-screen version), platform (all);

area (Beijing), source (all), platform (iPhone);

area (all), source (touch-screen version), platform (iPhone);

area (Beijing), source (all), platform (all);

area (all), source (all), platform (iPhone); and

area (all), source (all), platform (all).

Of course, in addition to the method of the Cartesian product operation, dimension combinations of all the dimensions may be calculated by using other methods, which is not limited in the embodiment.

In step 204, the hash value of each dimension combination of the client is respectively calculated. The push information matching the hash value is searched for. The push information searched out is returned to the client.

In this step, after obtaining all the dimension combinations of the client, the hash value of each dimension combination is calculated. The hash value of the dimension combination may be calculated by adopting the hash value of each dimension. In order to guarantee that a unique combination is determined by the hash value in the embodiment, uniqueness of a dimension value must be ensured. To achieve the uniqueness of the dimension value, all the integer dimension values are processed by bit segmentation in the embodiment, and different information is stored according to width. The calculating method is as below:

dimension type<<n 1 dimension level<<m 1 dimension value<<X|reserved field.

A dimension-type value is shifted to the left by N bit(s), or a value of the up dimension level is shifted to the left by M bit(s), or the up dimension value is shifted to the left by X bit(s), or the reserved field is shifted to the up by 1 bit. Four integers are compressed into one integer to represent a value of the dimension uniquely.

For example, the area to which the user belongs is Shijiazhuang in Hebei province of China, and dimensions satisfying the user are as follows:

China: 1<<31|1<<30|30<<25|reserved field;

Hebei province of China 1<<31|2<<30|65<<25| reserved field; and

Shijiazhuang in Hebei province of China 1<<31|3<<30|285<<25| reserved field.

The specific calculating method of the hash value is similar to a conventional method, which will not be described redundantly in the embodiment.

After a hash value of at least one dimension combination of the client is obtained, the hash value of each dimension combination of the client is respectively compared with a hash value of a corresponding dimension combination of the push information in the cache unit. When the hash value of each dimension combination of the client is equal to the hash value of the corresponding dimension combination of the push information, the push information corresponding to the hash value is searched out. For example, there are a dimension combination 1 and a dimension combination 2 in the client. Dimension combination 1 whose hash value is 25 is composed of an area (Beijing) and a platform (iPhone). Dimension combination 2 whose hash value is 36 is composed of an area (Beijing) and a service source (a space platform). There are a dimension combination 1 and a dimension combination 2 in the push information. Dimension combination 1 whose hash value is 36 is composed of an area (Beijing) and a service source (a space platform). Dimension combination 2 whose hash value is 25 is composed of an area (Beijing) and a platform (iPhone). Dimension combination 1 of the client is compared with corresponding dimension combination 2 of the push information. Dimension combination 2 of the client is compared with corresponding dimension combination 1 of the push information. When dimension combination 1 of the client is consistent with corresponding dimension combination 2 of the push information, meanwhile dimension combination 2 of the client is consistent with corresponding dimension combination 1 of the push information, the push information equal to the hash value is searched out.

In the embodiment, when the push information matching the hash value is not searched out in the cache unit, a null result is returned to the client.

Further, when the push information matching the hash value is not searched out in the cache unit, a correspondence between the push information having at least one dimension combination of the client and the at least one dimension combination is obtained from a loading unit. The calculated hash value of the dimension combination of the client is compared with the hash value of the dimension combination of the client. When the hash value of at least one dimension combination of the client is the same as the hash value of the dimension combination of the push information, the push information matching the hash value is obtained, and the push information is put into the cache unit. In the embodiment, to improve experience of the user, when there is no information that can be pushed to the client in the cache unit, data is re-pulled from the loading unit, so as to obtain the push information that can satisfy the client request, and finally the obtained push information is put into the cache unit. Subsequently, when there is a similar access request, the data directly pulled from the cache unit can be returned to the client. In the embodiment, when there is no matching push information in the cache unit, the push information may be obtained directly from the loading unit and returned to the client. Alternatively, a null result may be directly returned to the client, which is not limited in the embodiment.

The embodiment brings beneficial effects. An access request sent by a client is received. The access request carries information of the client. Dimensions of at least one category of the client are obtained according to the information of the client. The dimensions of at least one category of the client are combined dimensionally. At least one dimension combination of the client is obtained. A hash value of each dimension combination of the client is calculated. Push information matching the hash value is searched for. The push information searched out is returned to the client. The information may be pushed to the client, based on dimensions of at least one category of the client. Subsequently, needs of the client may be better met, efficiency for pushing information may be improved, resource occupation may be reduced, experience of a user browsing a microblog channel may also be improved.

Referring to FIG. 3, the embodiment provides a device for pushing information, which includes a receiving module 301, a dimension-combination obtaining module 302 and an information pushing module 303.

The receiving module 301 is configured to receive an access request sent by a client. The access request carries information of the client.

The dimension-combination obtaining module 302 is configured to obtain, according to the information of the client, dimensions of at least one category of the client, combine the dimensions of at least one category of the client dimensionally, and obtain at least one dimension combination of the client.

The information pushing module 303 is configured to calculate a hash value of each dimension combination of the client respectively, search for push information matching the hash value, and return the push information searched out to the client.

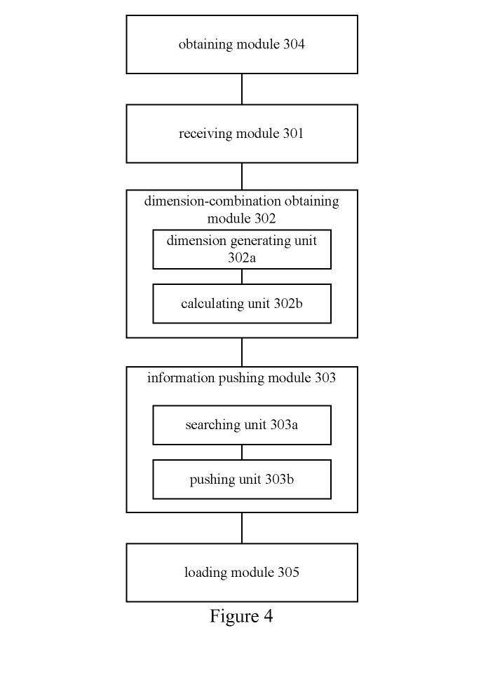

The information of the client includes at least one of: the capability information of the client, the IP address information, the version information of the browser and network information of the client. Referring to FIG. 4, the dimension-combination obtaining module 302 includes a dimension generating unit 302a, which is configured to obtain dimensions of at least one category of the client through at least one of following ways:

the capability information of the client is determined as a dimension of a first category of the client;

area information of the client, which is obtained based on the IP address information, is determined as a dimension of a second category of the client;

the version information of the browser is determined as a dimension of a third category of the client;

a service source of the client, which is obtained based on the version information of the browser, is determined as a dimension of a fourth category;

information of a network operator to which the client belongs, which is obtained based on the network information of the client, is determined as a dimension of a fifth category of the client;

at least one of gender and keyword of a client user, which is obtained based on the information of the client, may be determined as a dimension of a sixth category.

Referring to FIG. 4, the dimension-combination obtaining module 302 includes a calculating unit 302b.

The calculating unit 302b is configured to perform a Cartesian product operation on dimensions of at least one category of the client, and to obtain at least one dimension combination related to the client.

Referring to FIG. 4, the information pushing module 303 includes a searching unit 303a and a pushing unit 303b.

The searching unit 303a is configured to search for the push information matching the hash value in a cache unit.

The pushing unit 303b is configured to return the push information searched out to the client, when the push information matching the hash value has been searched out in the cache unit.

Referring to FIG. 4, the searching unit is configured to respectively compare the hash value of each dimension combination of the client with hash value of the corresponding dimension combination of the push information, and to search out the push information matching the hash value, when the hash value of each dimension combination of the client is the same as the hash value of the corresponding dimension combination of the push information.

Referring to FIG. 4, the device further includes an obtaining module 304.

When the push information matching the hash value is not searched out in the cache unit, the obtaining module 304 is configured to obtain from the loading unit correspondences between the push information having at least one dimension combination of the client and the at least one dimension combination, compare the calculated hash value of the dimension combination of the client and the hash value of the dimension combination of the push information. When there is a same hash value between hash values of all the dimension combination of the client and hash values of corresponding dimension combinations of the push information, the obtaining module 304 is further configured to obtain the push information matching the hash value, and store the push information in the cache unit.

Referring to FIG. 4, the device further includes a loading module 305.

The loading module 305 is configured to obtain correspondences between the push information and all the dimension combinations of the push information, before the receiving module receives the request sent by the client, and to obtain, according to the dimension combinations included in the obtained correspondences, types of all the dimensions in the dimension combinations and a largest level of each dimension, and calculate the hash value of each dimension combination.

The embodiment brings beneficial effects. An access request sent by a client is received. The access request carries information of the client. Dimensions of at least one category of the client are obtained according to the information of the client. The dimensions of at least one category of the client are combined dimensionally. At least one dimension combination of the client is obtained. A hash value of each dimension combination of the client is calculated. Push information matching the hash value is searched for. The push information searched out is returned to the client. The information may be pushed to the client, based on dimensions of at least one category of the client. Subsequently, needs of the client may be better met, efficiency for pushing information may be improved, resource occupation may be reduced, experience of a user browsing a microblog channel may also be improved.

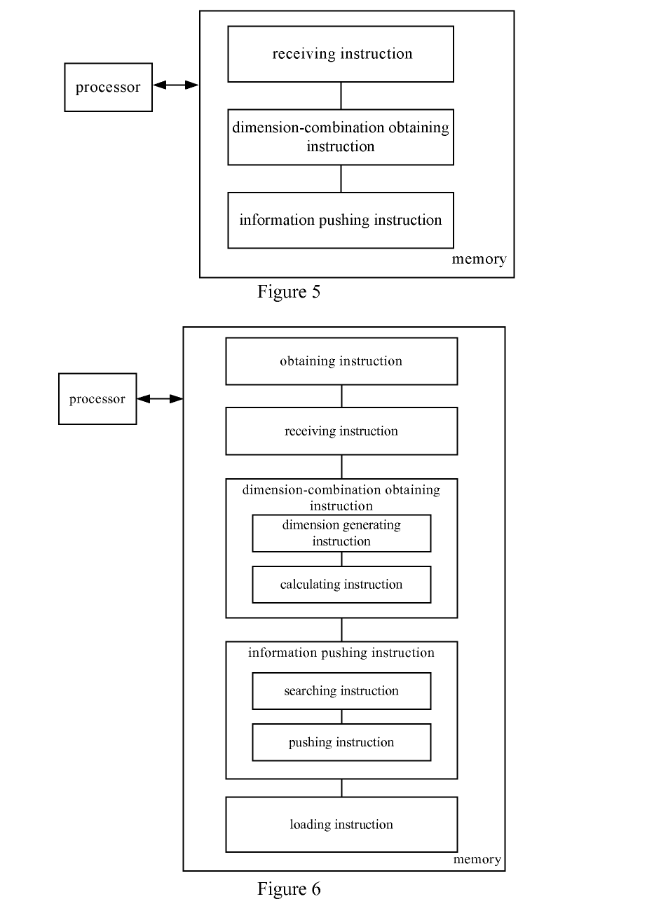

FIG. 5 is a schematic diagram illustrating structure of a device for pushing information provided by an embodiment of the present invention. As shown in FIG. 5, the device at least includes a memory and a processor in communication with the memory. The memory stores a receiving instruction, a dimension-combination obtaining instruction and an information pushing instruction, which may be executed by the processor.

The receiving instruction is to receive an access request sent by a client. The access request carries information of the client.

The dimension-combination obtaining instruction is to obtain, according to the information of the client, dimensions of at least one category of the client, combine the dimensions of at least one category of the client dimensionally, and obtain at least one dimension combination of the client.

The information pushing instruction is to respectively calculate a hash value of each dimension combination of the client, search for push information matching the hash value, and return the push information searched out to the client.

The information of the client includes at least one of: capability information of the client, the IP address information, the version information of the browser and network information of the client. Referring to FIG. 6, the dimension-combination obtaining instruction includes a dimension generating instruction, which is configured to obtain dimensions of at least one category of the client through at least one of following ways:

the capability information of the client is determined as a dimension of a first category of the client;

area information of the client, which is obtained based on the IP address information, is determined as a dimension of a second category of the client;

the version information of the browser is determined as a dimension of a third category of the client;

a service source of the client, which is obtained based on the version information of the browser, is determined as a dimension of a fourth category;

information of a network operator to which the client belongs, which is obtained based on the network information of the client, is determined as a dimension of a fifth category of the client; and

at least one of gender and keyword of a client user, which may be obtained based on the information of the client, may be determined as a dimension of a sixth category.

Referring to FIG. 6, the dimension-combination obtaining instruction includes a calculating instruction.

The calculating instruction is to perform a Cartesian product operation on dimensions of at least one category of the client, and to obtain at least one dimension combination related to the client.

Referring to FIG. 6, the information pushing instruction includes a searching instruction and a pushing instruction.

The searching instruction is to search for the push information matching the hash value in a cache unit.

When the push information matching the hash value is searched out in the cache unit, the pushing instruction is to return the push information searched out to the client.

Referring to FIG. 6, the searching instruction is configured to compare the hash value of each dimension combination of the client with a hash value of a corresponding dimension combination of the push information in the cache unit respectively, and to search out the push information matching the hash value, when the hash value of each dimension combination of the client is the same as the hash value of the corresponding dimension combination of the push information.

Referring to FIG. 6, the device further includes an obtaining instruction.

When the push information matching the hash value is not searched out in the cache unit, the obtaining instruction is to obtain a correspondence between the push information having at least one dimension combination of the client and the at least one dimension combination from a loading unit, and to compare the calculated hash value of the dimension combination of the client with the hash value of the dimension combination of the push information. When there is a same hash value between hash values of all dimension combinations of the client and hash values of corresponding dimension combinations of the push information, the obtaining instruction is further to obtain the push information matching the hash value, and store the push information into the cache unit.

Referring to FIG. 6, the device further includes a loading instruction.

The loading instruction is to obtain correspondences between the push information and all the dimension combinations of the push information, before the receiving module receives the request sent by the client, and to obtain, according to the dimension combinations included in the obtained correspondences, types of all the dimensions in the dimension combinations and a largest level of each dimension, and calculate the hash value of each dimension combination.

The embodiment brings beneficial effects. An access request sent by a client is received. The access request carries information of the client. Dimensions of at least one category of the client are obtained according to the information of the client. The dimensions of at least one category of the client are combined dimensionally. At least one dimension combination of the client is obtained. A hash value of each dimension combination of the client is calculated. Push information matching the hash value is searched for. The push information searched out is returned to the client. The information may be pushed to the client, based on dimensions of at least one category of the client. Subsequently, needs of the client may be better met, efficiency for pushing information may be improved, resource occupation may be reduced, experience of a user browsing a microblog channel may also be improved.

In addition, the device and the method for pushing information provided by the above-mentioned embodiments have a same inventive concept. The specific implementation process may refer to method embodiments, which will not be repeated here.

Serial numbers in the above-mentioned embodiments are just for the sake of description, which do not represent the pros and cons of the embodiments.

One skilled in the art may understand that implementation of all or part of steps in the method of the above embodiments may be completed by hardware or by instructing related hardware through a program. The program may be stored in a computer readable storage medium. The storage medium may be a read-only memory, a magnetic disk or an optical disk, etc.

The foregoing is merely a preferred embodiment of the present invention, which is not to limit the present invention. Any modifications, equivalent substitutions and improvements made within the spirit and principle of the present invention, should be covered by the protection scope of the present invention.

1. A method for pushing information, comprising:
receiving an access request sent by a client, wherein the access request carries information of the client;
obtaining, according to the information of the client, dimensions of at least one category of the client, combining the dimensions of at least one category of the client dimensionally, and obtaining at least one dimension combination of the client; and
for each dimension combination of the client, calculating a hash value of the dimension combination, searching for push information matching the hash value, and returning the push information searched out to the client.

2. The method according to claim 1, wherein the information of the client comprises at least one of: capability information of the client, Internet Protocol (IP) address information, version information of a browser, and one or more pieces of network information of the client, and the dimensions of at least one category of the client are obtained through at least one of:
determining the capability information of the client as a dimension of a first category of the client;
obtaining, according to the IP address information, area information of the client, and determining the area information of the client as a dimension of a second category of the client;
determining the version information of the browser as a dimension of a third category of the client;
obtaining, according to the version information of the browser, a service source of the client, and determining the service source of the client as a dimension of a fourth category;
obtaining, according to the network information of the client, information of a network operator to which the client belongs, and determining the information of the network operator to which the client belongs as a dimension of a fifth category of the client; and
obtaining, according to the information of the client, a gender of a client user, and/or, a keyword of a client user, determining the gender of the client user and/or the keyword of the client user as a dimension of a sixth category.

3. The method according to claim 1, wherein combining the dimensions of at least one category of the client dimensionally and obtaining at least one dimension combination of the client comprise:
performing a Cartesian product operation on the dimensions of at least one category of the client, and obtaining at least one dimension combination of the client.

4. The method according to claim 1, wherein searching for push information matching the hash value and returning the push information searched out to the client comprise:
searching for the push information matching the hash value in a cache unit; and
returning the push information searched out to the client, when the push information matching the hash value is searched out in the cache unit.

5. The method according to claim 4, further comprising:
obtaining a correspondence between the push information having the at least one dimension combination of the client and the at least one dimension combination from a loading unit, when the push information matching the hash value is not searched out in the cache unit; and
comparing the hash value of each dimension combination of the client with hash value of each dimension combination of the push information respectively, and storing the push information into the cache unit, when there is a same hash value between hash values of all dimension combinations of the client and hash values of corresponding dimension combinations of the push information.

6. The method according to claim 4, wherein searching for the push information matching the hash value in the cache unit comprises:
comparing the hash value of each dimension combination of the client with the hash value of dimension combination of the corresponding push information in the cache unit respectively; and
searching out the push information matching the hash value, when the hash value of each dimension combination of the client is the same as the hash value of the corresponding dimension combination of the push information.

7. The method according to claim 1, further comprising:
obtaining a correspondence between the push information and all dimension combinations of the push information, before receiving the access request sent by the client; and
obtaining, according to the dimension combinations comprised in the obtained correspondence, categories of all the dimensions of the push information and the largest level of each dimension, and calculating the hash value of each dimension combination.

8. A device for pushing information, comprising:
a receiving module, configured to receive an access request sent by a client, wherein the access request carries information of the client;
a dimension-combination obtaining module, configured to obtain, according to the information of the client, dimensions of at least one category of the client, combine the dimensions of at least one category of the client dimensionally, and obtain at least one dimension combination of the client; and
an information pushing module, configured to calculate a hash value of each dimension combination of the client respectively, search for push information matching the hash value, and return the push information searched out to the client.

9. The device according to claim 8, wherein the information of the client comprises at least one of: capability information of the client, Internet Protocol (IP) address information, version information of a browser and network information of the client, and the dimension-combination obtaining module comprises a dimension generating unit which is configured to obtain dimensions of at least one category of the client through at least one of:
determining the capability information of the client as a dimension of a first category of the client;
obtaining, according to the IP address information, area information of the client, and determining the area information of the client as a dimension of a second category of the client;
determining the version information of the browser as a dimension of a third category of the client;
obtaining, according to the version information of the browser, a service source of the client, and determining the service source of the client as a dimension of a fourth category;
obtaining, according to the network information of the client, information of a network operator to which the client belongs, and determining the information of the network operator to which the client belongs as a dimension of a fifth category; and
obtaining, according to the information of the client, a gender of a client user and/or a keyword of a client user, determining the gender of the client user and/or the keyword of the client user as a dimension of a sixth category.

10. The device according to claim 8, wherein the dimension-combination obtaining module comprises:
a calculating unit, configured to perform a Cartesian product operation on at least one dimension of the client, and to obtain at least one dimension combination of the client.

11. The device according to claim 8, wherein the information pushing module comprises:
a searching unit, configured to search for the push information matching the hash value in a cache unit; and
a pushing unit, configured to return the push information searched out to the client, when the push information matching the hash value has been searched out in the cache unit.

12. The device according to claim 11, wherein the device further comprises:
an obtaining module, configured to obtain a correspondence between the push information having at least one dimension combination of the client and the at least one dimension combination from a loading unit, when the push information matching the hash value is not searched out in the cache unit, and to compare the calculated hash value of the dimension combination of the client with the hash value of the dimension combination of the push information, obtain the push information matching the hash value, when there is a same hash value between hash values of all dimension combinations of the client and hash values of corresponding dimension combinations of the push information, and store the push information into the cache unit.

13. The device according to claim 11 or 12, wherein the searching unit in the information pushing module is configured to compare the hash value of each dimension combination of the client with the hash value of the corresponding dimension combination of the push information respectively, and to search out the push information matching the hash value, when the hash value of each dimension combination of the client is the same as the hash value of the corresponding dimension combination of the push information.

14. The device according to claim 8, wherein the device further comprises:
a loading module, configured to obtain a correspondence between the push information and all dimension combinations of the push information, before the receiving module receives the access request sent by the client, and to obtain, according to the obtained correspondence with the dimension combinations, categories of all the dimensions in the dimension combination and a largest level of each dimension, and calculate the hash value of each dimension combination.
